(19) United States
(12) Patent Application Publication
(10) Pub. No.: US 2013/0013867 A1
(43) Pub. Date: Jan. 10, 2013

(54) DATA PREFETCHER MECHANISM WITH INTELLIGENT DISABLING AND ENABLING OF A PREFETCHING FUNCTION

(75) Inventors: Srilatha Manne, Portland, OR (US); Steven K. Reinhardt, Vancouver, WA (US)

(73) Assignee: ADVANCED MICRO DEVICES, INC., Sunnyvale, CA (US)

(21) Appl. No.: 13/177,419

(22) Filed: Jul. 6, 2011

(51) Int. Cl. G06F 12/08

(52) U.S. Cl. 711/137; 711/E12.057

(57) ABSTRACT

A data prefetcher includes a controller to control operation of the data prefetcher. The controller receives data associated with cache misses and data associated with events that do not rely on a prefetching function of the data prefetcher. The data prefetcher also includes a counter to maintain a count associated with the data prefetcher. The count is adjusted in a first direction in response to detection of a cache miss, and in a second direction in response to detection of an event that does not rely on the prefetching function. The controller disables the prefetching function when the count reaches a threshold value.

### TECHNICAL FIELD

Embodiments of the subject matter described herein relate generally to processors. More particularly, embodiments of the subject matter relate to caching and prefetching elements of a processor.

### BACKGROUND

A central processing unit (CPU) may include or cooperate with one or more cache memories to facilitate quick access to data (rather than having to access data from the primary system memory). Memory latency, relative to CPU performance, is ever increasing. Caches can alleviate the average latency of a load operation by storing frequently accessed data in structures that have significantly shorter latencies associated therewith. However, caches can suffer from “cold misses” where the data has never been requested before, and from “capacity misses” where the cache is too small to hold all the data required by the requesting application.

To make caches more effective, data prefetchers are used to prefetch data ahead of when the data is actually required by the application. When effective, prefetchers can boost performance by reducing the average latency of loads. However, prefetchers can also be detrimental to overall CPU performance in a number of ways. For example, prefetchers generate prefetch requests that must be filtered through the cache tag array before the prefetch requests can be sent to subsequent levels of cache or memory. If a prefetch request hits in the tag array, the prefetch request is squashed. Although such squashed requests do not generate traffic beyond the current cache level, they contend with demand requests that are also trying to access the same tag array. In addition, the tag access also consumes energy.

Another downside to traditional data prefetcher designs is that they might prefetch useful cache lines too early, or prefetch cache lines that go unused by the application. In either scenario, the prefetcher displaces potentially useful data in the cache with untimely or useless data. This not only results in a performance loss, but also increases energy consumption.

### BRIEF SUMMARY OF EMBODIMENTS

An exemplary embodiment of a method of operating a data prefetcher is provided herein. The method maintains a count associated with the data prefetcher, adjusts the count in a first direction in response to detection of an event that indicates non-utilization of a prefetching function of the data prefetcher, and adjusts the count in a second direction in response to detection of an event that indicates utilization of the prefetching function. The method temporarily disables the prefetching function when the count satisfies disable criteria, resulting in a disabled prefetcher state.

Also provided is an exemplary embodiment of a data prefetcher. The prefetcher includes: a controller to control operation of the data prefetcher, the controller configured to receive data associated with cache misses and data associated with events that do not rely on a prefetching function of the data prefetcher; and a counter to maintain a count associated with the data prefetcher. The count is adjusted in a first direction in response to detection of a cache miss, and in a second direction in response to detection of an event that does not rely on the prefetching function. The controller disables the prefetching function when the count reaches a threshold value.

An exemplary embodiment of a processor system is also provided. The system includes: an execution core; a cache memory coupled to the execution core; and a data prefetcher coupled to the cache memory. A prefetching function of the data prefetcher is disabled upon detection of a sequence of events that do not utilize the prefetching function.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram representation of an exemplary embodiment of a processor system;

FIG. 2 is a schematic block diagram representation of an exemplary embodiment of a data prefetcher, which is suitable for use in the processor system shown in FIG. 1;

FIG. 3 is a flow chart that illustrates an exemplary embodiment of a method of operating a data prefetcher; and

FIG. 4 is a flow chart that illustrates another exemplary embodiment of a method of operating a data prefetcher.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following

### DETAILED DESCRIPTION

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, logic elements, look-up tables, or the like, which may carry out a variety of functions under the control of one or more microprocessors or other control devices.

The subject matter presented here relates to a processor system and associated data prefetcher(s). The data prefetcher and/or one or more other modules or elements of the processor system determines when the data prefetcher is generating prefetch requests that are either useless and consume unnecessary power, or are otherwise detrimental to processor performance. The mechanism described here takes advantage of the observation that cache misses (and, conversely, hits) tend to be clustered. In other words, if a cache miss occurs, then there is a high probability that other cache misses will be temporally nearby. Accordingly, the prefetching function of the data prefetcher is temporarily disabled if a cache miss (or misses) has not been detected during a certain period. The data prefetcher does not issue prefetch requests during this disabled state and, therefore, power and resources are not wasted. The prefetching function is enabled if a miss is detected while the data prefetcher is in the disabled state.

The approach described herein intelligently reduces prefetch pollution at a number of levels. First, it uses the observation that misses tend to be clustered. Therefore, if a miss has not been detected for a long period of time (as measured in accordance with certain events being tracked), then the data prefetcher might be generating prefetch requests for data that is not likely to be used in a timely manner. Second, if there are no cache misses for some period of time, the application might be working out of the current or higher levels of cache memory. Therefore, there is likely to be a steady stream of demand traffic to the cache, and any traffic generated by the prefetcher will only hold up demand requests by contending for the cache tag array. In practice, the approach presented here can be used at any number of cache memory levels, (e.g., L1, L2, and/or L3), and it can be used to throttle either the data stream prefetchers or the instruction stream prefetchers.

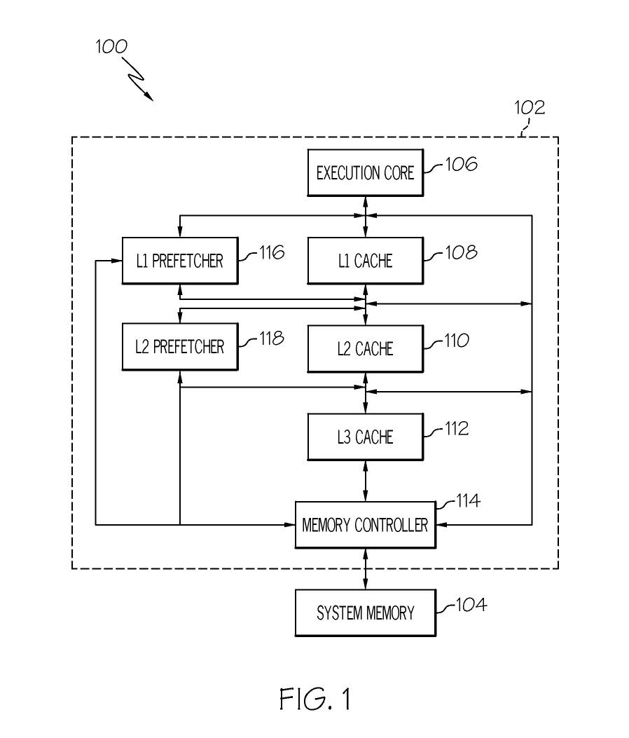

Referring now to the drawings, FIG. 1 is a schematic block diagram representation of an exemplary embodiment of a processor system 100. FIG. 1 depicts a simplified rendition of the processor system 100, which may include a processor 102 and system memory 104 coupled to the processor 102. In the embodiment shown, the processor 102 includes, without limitation: an execution core 106; a level one (L1) cache memory 108; a level two (L2) cache memory 110; a level three (L3) cache memory 112; and a memory controller 114. The cache memories 108, 110, 112 are coupled to the execution core 106, and are coupled together to form a cache hierarchy, with the L1 cache memory 108 being at the top of the hierarchy and the L3 cache memory 112 being at the bottom. The execution core 106 may represent a processor core that issues demand requests for data. Responsive to demand requests issued by the execution core 106, one or more of the cache memories 108, 110, 112 may be searched to determine if the requested data is stored therein. If the data is found in one or more of the cache memories 108, 110, 112, the highest-level cache memory may provide the data to the execution core 106. For example, if the requested data is stored in all three cache memories 108, 110, 112, it may be provided by the L1 cache memory 108 to the execution core 106.

In one embodiment, the cache memories 108, 110, 112 may become progressively larger as their priority becomes lower. Thus, the L3 cache memory 112 may be larger than the L2 cache memory 110, which may in turn be larger than the L1 cache memory 108. It is also noted that the processor 102 may include multiple instances of the execution core 106, and that one or more of the cache memories 108, 110, 112 may be shared between two or more instances of the execution core 106. For example, in one embodiment, two execution cores 106 may share the L3 cache memory 112, while each execution core 106 may have separate, dedicated instances of the L1 cache memory 108 and the L2 cache memory 110. Other arrangements are also possible and contemplated.

The processor 102 also includes the memory controller 114 in the embodiment shown. The memory controller 114 may provide an interface between the processor 102 and the system memory 104, which may include one or more memory banks. The memory controller 114 may also be coupled to each of the cache memories 108, 110, 112. More particularly, the memory controller 114 may load cache lines (i.e., blocks of data stored in a cache memory) directly into any one or all of the cache memories 108, 110, 112. In one embodiment, the memory controller 114 may load a cache line into one or more of the cache memories 108, 110, 112 responsive to a demand request by the execution core 106 and resulting cache misses in each of the cache memories 108, 110, 112.

In the embodiment shown, the processor 102 also includes an L1 data prefetcher 116 and an L2 data prefetcher 118. The L1 data prefetcher 116 is coupled to (or is otherwise associated with) the L1 cache memory 108, and the L2 data prefetcher 118 is coupled to (or is otherwise associated with) the L2 cache memory 110. The L1 data prefetcher 116 may be configured to load prefetched cache lines into the L1 cache memory 108. A cache line may be prefetched by the L1 data prefetcher 116 from a lower level memory, such as the L2 cache memory 110, the L3 cache memory 112, or the system memory 104 (via the memory controller 114). Similarly, the L2 data prefetcher 118 may be configured to load prefetched cache lines into the L2 cache memory 110, and may prefetch such cache lines from the L3 cache memory 112 or from the system memory 104 (via the memory controller 114). In the embodiment shown, there is no data prefetcher associated with the L3 cache memory 112, although embodiments wherein such a prefetcher is utilized are possible and contemplated. It is also noted that embodiments utilizing a unified prefetcher to serve multiple caches (e.g., a prefetcher serving both the L1 and L2 cache memories 108, 110) are also possible and contemplated, and that such embodiments may perform the various functions of the data prefetchers that are to be described herein.

Prefetching performed by the L1 data prefetcher 116 and the L2 data prefetcher 118 may be used to obtain cache lines containing certain types of speculative data. Speculative data may be data that is loaded into a cache memory in anticipation of its possible use. For example, if a demand request causes a cache line containing data at a first memory address to be loaded into a cache memory, at least one of the data prefetchers 116, 118 may load another cache line containing data from one or more nearby addresses, based on the principle of spatial locality. In general, speculative data may be any type of data which may be loaded into a cache memory based on the possibility of its use, although its use is not guaranteed. Accordingly, a cache line that contains speculative data may or may not be the target of a demand request by the execution core 106, and thus may or may not be used.

It is also noted that the processor 102 does not include prefetch buffers in the embodiment shown. In some embodiments, however, prefetch buffers may be used in conjunction with the data prefetchers 116, 118 in order to provide temporary storage for prefetched data in lieu of immediately caching the data. The use of prefetch buffers is also contemplated by this description and prefetch buffers could be implemented if so desired.

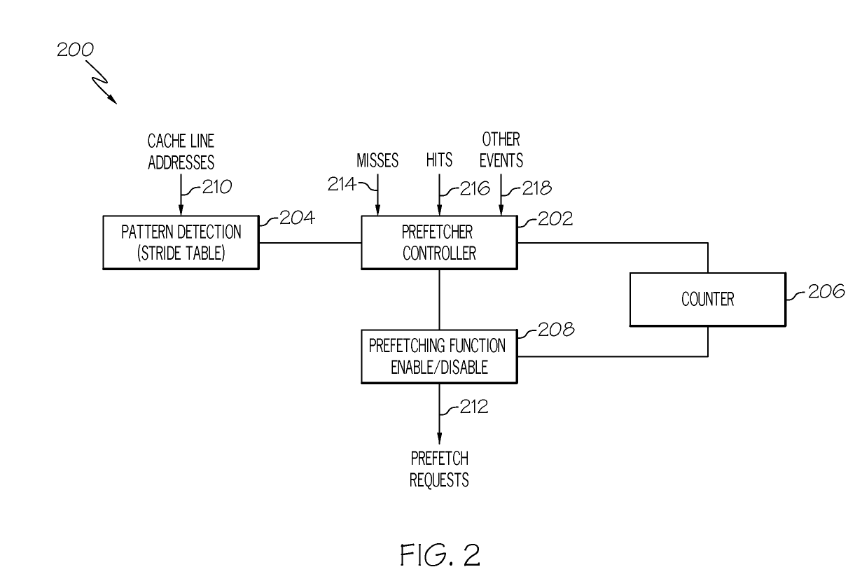

FIG. 2 is a schematic block diagram representation of an exemplary embodiment of a data prefetcher 200, which is suitable for use in the processor system shown in FIG. 1. In this regard, the data prefetcher 200 shown in FIG. 2 could be used for the L1 data prefetcher 116 and the L2 data prefetcher 118 shown in FIG. 1. Alternatively, the data prefetcher 200 could be utilized in a memory controller or in any structure, module, or device that is responsible for moving data from one memory structure to another. The illustrated embodiment of the data prefetcher 200 includes, without limitation: a prefetcher controller 202; a pattern detection module 204 coupled to the prefetcher controller 202; a counter 206 coupled to the prefetcher controller 202; and a prefetching function enable/disable module 208 coupled to (or integrated with) the prefetcher controller 202.

The data prefetcher 200 is associated with a respective cache memory. As is well understood, a cache memory can have access events (“hits”) or non-access events (“misses”) associated therewith. A cache hit means that requested data is contained in the cache, and a miss means that the cache does not contain the requested data. The data prefetcher 200 may function in a conventional manner to monitor the stream of hits and/or misses (typically both) corresponding to the cache memory assigned to or coupled to the data prefetcher 200. Accordingly, the prefetcher controller 202 may be suitably configured to carry out various operations, tasks, and processes described in more detail herein, and to otherwise control the operation of the data prefetcher 200. The illustrated embodiment employs the pattern detection module 204 to determine whether or not there is a discernable or known pattern of cache line requests. To this end, the pattern detection module 204 can monitor the cache line addresses 210 corresponding to issued data requests and compare the pattern of addresses to entries in a pattern table, as is well understood. The data prefetcher 200 may employ other prefetching techniques and methodologies in addition to pattern detection.

The data prefetcher 200 can generate and issue prefetch requests 212 that include or correspond to prefetch addresses. In this regard, the data prefetcher 200 monitors the addresses that miss its cache memory and generates prefetch requests when it determines that certain addresses might be called for in the near future. More particularly, the data prefetcher 200 may attempt to detect a stride pattern among miss (or hit) addresses and may generate the next address in the pattern if a stride access pattern is detected by the pattern detection module 204.

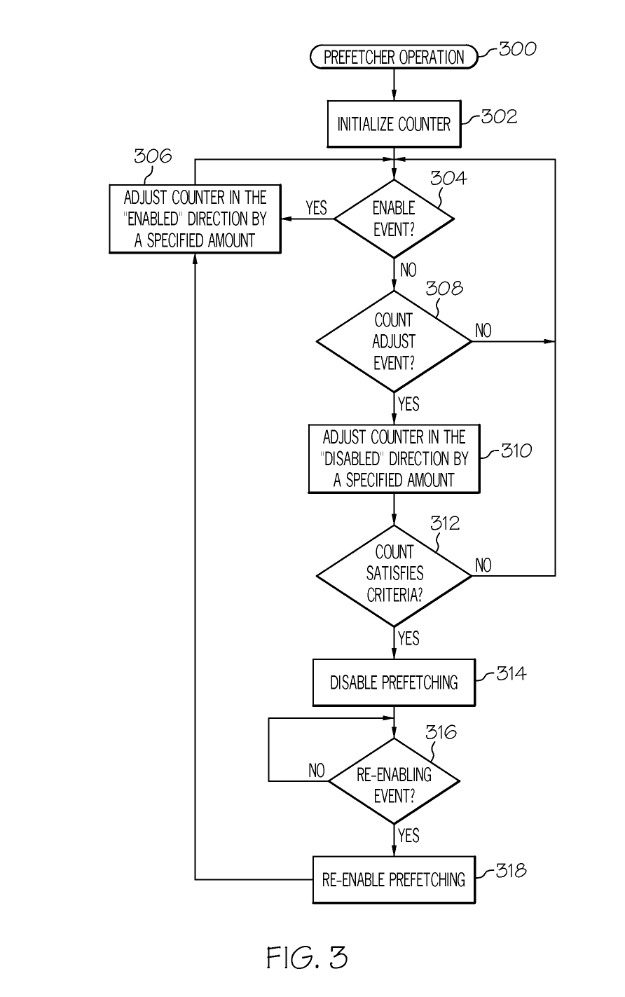

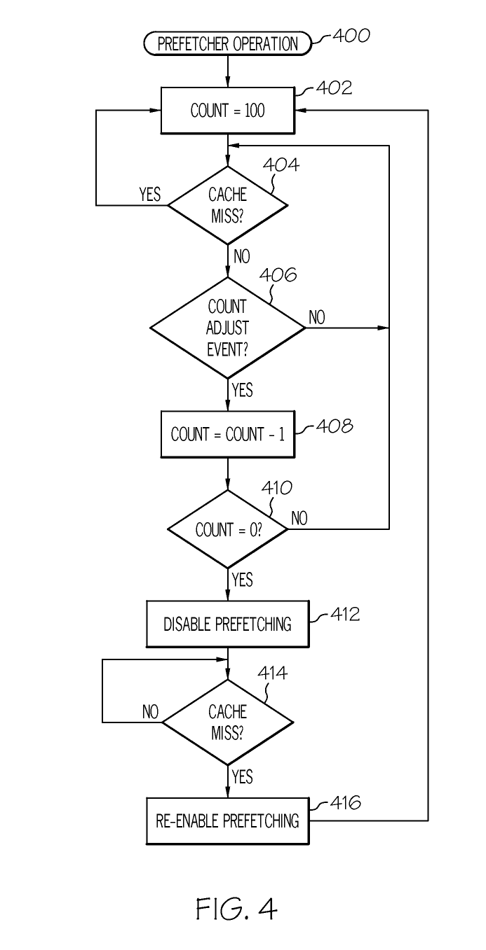

The data prefetcher 200 employs an intelligent enable/disable feature that inhibits the generation and issuance of prefetch requests under certain detected operating conditions. As explained in more detail below with reference to FIG. 3 and FIG. 4, the data prefetcher 200 uses the counter 206 as a mechanism for keeping track of certain events (e.g., misses and/or hits) that indicate actual or predicted non-utilization of a prefetching function and that indicate actual or predicted utilization of the prefetching function. In practice, the counter 206 maintains a count associated with the data prefetcher 200, where the value of the count determines whether or not the prefetching function of the data prefetcher 200 is disabled. If detected events and conditions indicate that prefetching of data is unnecessary, then the prefetching function enable/disable module 208 disables the prefetching function such that the data prefetcher 200 does not generate any prefetch requests while it remains in the disabled state. On the other hand, if detected events and conditions indicate that prefetching of data is necessary or will be necessary in the immediate future, then the prefetching function enable/disable module 208 enables the prefetching function such that the data prefetcher 200 can operate as usual by issuing prefetch requests under the control of the prefetcher controller 202.

For this exemplary embodiment, the enable/disable decision is influenced or dictated by one or more inputs to the data prefetcher 200. For example, the data prefetcher 200 may operate in response to the detection of misses 214, the detection of hits 216, and/or the detection of any number of other events 218 that could be monitored, measured, observed, or detected by the data prefetcher 200. Although FIG. 2 shows these inputs received by the prefetcher controller 202, an embodiment of the data prefetcher 200 could receive the inputs at other elements or modules, such as the pattern detection module 204 or the prefetching function enable/disable module 208.

The processor system 100 and the data prefetcher 200 may be suitably configured to operate in the manner described in detail below. For example, FIG. 3 is a flow chart that illustrates an exemplary embodiment of a prefetcher operation process 300, which may be performed by the processor system 100 and/or the data prefetcher 200. The various tasks performed in connection with a process described here may be performed by software, hardware, firmware, or any combination thereof. For illustrative purposes, the description of a process may refer to elements mentioned above in connection with FIG. 1 and FIG. 2. In practice, portions of a described process may be performed by different elements of the described system, e.g., the prefetcher controller, the memory controller, or other logic in the system. It should be appreciated that a described process may include any number of additional or alternative tasks, the tasks shown in the figures need not be performed in the illustrated order, and that a described process may be incorporated into a more comprehensive procedure or process having additional functionality not described in detail herein. Moreover, one or more of the tasks shown in the figures could be omitted from an embodiment of a described process as long as the intended overall functionality remains intact.

For ease of description and clarity, this example assumes that the process 300 begins by initializing or resetting the prefetcher counter to its initial value (task 302). Depending upon how the counter is implemented, the initial value may be a minimum value, a maximum value, or any chosen starting counter value. This particular embodiment employs and maintains a decay counter and the initial count value represents a maximum value. For the example described here, the maximum count value is arbitrarily chosen to be one hundred. Alternatively, the counter may be implemented as an incrementing counter with a minimum value or zero as its initial count value. After initializing the counter, the process 300 may proceed by monitoring certain data or inputs to determine whether or not it is likely that the prefetcher is (or immediately will be) performing prefetching operations, whether or not it is likely that the prefetcher will not be needed in the immediate future, etc.

If the process 300 receives data or information indicative of an enable event or otherwise detects the occurrence of an enable event (query task 304), then the counter is adjusted in the enabled direction by some amount (task 306). The word “enabled” in this context refers to the enabling of the prefetcher function. As used here, an “enable event” represents a detectable event, condition, parameter, operating condition, or phenomena that indicates current or impending utilization of the prefetching function, current or impending reliance on the prefetching function, current or impending need to have the prefetching function available, or the like. A data stream cache miss may be considered to be an enable event. As another example, instruction stream misses (ICache misses) and TLB misses may also serve as indicators of the program changing state and potentially requiring the prefetcher to be operational again. Another approach could tab each prefetched block with a flag indicating that it was prefetched. This flag bit is set when the block is prefetched, and cleared on the first hit to the block by a demand request. A hit on a cache block with the prefetch bit set could be used as an indicator for enabling the prefetcher. For the exemplary embodiment presented here, a data cache miss is an enable event. In practice, an enable event could be defined to be any number of cache misses that occur within a designated period of time, during a specified number of cycles, etc. Thus, the “Yes” branch of query task 304 may be followed in response to the detection of a single cache miss, or in response to the detection of at least N cache misses over a predetermined period of time.

Task 306 adjusts the counter in the “enabled” direction in response to the detection of any predefined enable event. In other words, task 306 adjusts the counter value toward the initial count value. Notably, task 306 will have no effect if the current count value is already at its initial count value. Moreover, the adjustment associated with task 306 could be capped or limited once the initial count value is reached. The exemplary embodiment described here treats the initial count value as a maximum value, and task 306 increments the current count value by some amount. In some embodiments, task 306 increments the current count value by a predetermined amount. In other embodiments, task 306 simply resets or reinitializes the counter to its initial count value.

If query task 304 does not detect, measure, or observe an enable event, then the process may proceed to a query task 308 to determine whether or not a count adjust event has occurred. As used here, a “count adjust event” represents a detectable event, condition, parameter, operating condition, or phenomena that indicates current or ongoing non-utilization of the prefetching function, current or ongoing non-reliance on the prefetching function, no need to have the prefetching function available, or the like. In other words, a count adjust event indicates that a prefetch request need not be issued now or in the immediate future. For this particular example, a count adjust event may represent, without limitation: the passage of an amount of time; an amount of time cycles; cache accesses to the prefetcher's cache; cache accesses to a cache other than the prefetcher's cache; a number of load requests; or the like.

If a count adjust event is not detected (the “No” branch of query task 308), the process 300 may loop back to query task 304 to continue monitoring for an enable event and/or a count adjust event. Notably, query tasks 304, 306 form a loop that repeats itself until either an enable event or a count adjust event is detected. The current count remains the same during this processing loop.

If the process 300 detects a count adjust event (query task 308), such as one or more hits or accesses to the cache memory and/or the passage of a specified amount of time without a cache miss, then the counter is adjusted in the disabled direction by a specified amount (task 310). As used here, the “disabled direction” refers to a decrease or increase in the counter value toward a threshold or criteria value that triggers disabling of the prefetching function. For this exemplary embodiment, which employs a decay counter, task 310 decrements the counter in response to the detection of a count adjust event. Task 310 may adjust the count by any desired amount, and the specific adjustment amount might vary depending on the type of count adjust event detected, observed characteristics of the detected count adjust event, the current operating state or condition of the data prefetcher, the current operating state or condition of the cache memory to which the data prefetcher is assigned, the current operating state or condition of the processor, etc.

After adjusting the count value toward the disable state, the process 300 may check whether the current value of the counter satisfies certain predetermined criteria, e.g., whether the current counter value has reached a triggering threshold value (query task 312). If not, then the process 300 may lead back to query task 304 to continue monitoring for an enable event and/or another count adjust event. If so, then the process 300 temporarily disables the prefetching function of the data prefetcher (task 314). The exemplary embodiment of the process 300 employs a simple count threshold or a minimum count value to trigger disabling of the prefetching function. For this example, the count threshold is zero. Therefore, the prefetching function is disabled when the current count value reaches zero. This places the data prefetcher into its disabled state. It should be appreciated that the process 300 can be executed such that the prefetching function of the prefetcher is disabled upon detection of a sequence of events that do not utilize or rely on the prefetching function. Such disabling is speculative in nature in that the prefetcher assumes that its prefetching function will not be needed in the immediate future, based on current and past conditions.

Even though the prefetching function has been disabled, other functions and operations performed by and otherwise associated with the data prefetcher may remain active. For example, training and pattern recognition functions of the data prefetcher may remain active and ongoing even though prefetch request generation and issuance have been disabled. This allows the data prefetcher to continue performing other functions while its prefetch request function has been suppressed.

The process 300 continues to monitor for a re-enabling event, even though the prefetcher is operating in its disabled state. In this regard, if a re-enabling event is detected (query task 316) when the prefetcher is in the disabled state, the process 300 re-enables the prefetching function and places the data prefetcher back into its enabled state (task 318). In practice, a “re-enabling event” may be defined as set forth above for an “enable event.” Accordingly, query task 316 may be designed to detect the occurrence of one or more cache misses during a disabled period. The prefetching function is re-enabled under these circumstances because the re-enabling event utilizes the prefetching function, will soon require the prefetching function, or is indicative of an immediate or impending need to use or rely on the prefetching function.

In response to the re-enabling of the data prefetcher, the process 300 adjusts the counter in the enabled direction (task 306), as described above. In certain embodiments, at this time the counter is reset to its initial count value. For example, the counter returns to its starting value of one hundred for the exemplary embodiment presented here. Thereafter, the process 300 continues in the manner described above.

For the sake of completeness, FIG. 4 is a flow chart that illustrates one particular exemplary embodiment of a prefetcher operation process 400. The process 400 is similar to the process 300, and common tasks and features will not be redundantly described below. The process 400 is shown and described to illustrate one possible implementation.

The process 400 begins by initializing the count to its maximum value of one hundred (task 402). Thereafter, if at least one cache miss is detected (query task 404), the count is reset to the initial value of one hundred. If a cache miss is not detected, then the process 400 determines whether or not a count adjust event has been detected (query task 406). If a count adjust event is not detected, the process 400 returns to query task 404. If a count adjust event is detected, the counter is decremented by one to obtain a new count value (task 408). If the new count value equals zero (query task 410), the prefetching function of the prefetcher is disabled (task 412). If the new count value remains greater than zero (the “No” branch of query task 410), the process 400 returns to query task 404.

As mentioned previously, the prefetcher need not be completely disabled at task 412. In certain embodiments only the prefetching function is suppressed at this time. While the prefetcher is operating in this disabled mode, the process 400 continues to monitor for cache misses. If a cache miss is detected (query task 414), the prefetching function is re-enabled (task 416) and the counter is reset to the initial count value of one hundred. Thereafter, the process 400 continues as described above to dynamically disable and enable the prefetching function of the data prefetcher.

The embodiments described above contemplate a global disabling of the prefetching function. In other words, the prefetching function is disabled for all strides and patterns considered by the data prefetcher. This global approach disables the prefetching function for all monitored patterns when the count satisfies the threshold criteria. An alternate embodiment could selectively disable the prefetching function on a pattern-by-pattern basis. Yet another embodiment could selectively disable the prefetching function for designated groups of patterns monitored by the data prefetcher. Thus, if no cache misses are detected for a particular pattern (or group of patterns) over a given period of time, the prefetching function for that particular pattern (or group of patterns) is disabled while leaving the prefetching function available and active for all other patterns. This alternate approach allows the data prefetcher to differentiate between patterns and not globally react to only one pattern that triggers the disabled state.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a data prefetcher, the method comprising:
maintaining a count associated with the data prefetcher;
adjusting the count in a first direction in response to detection of an event that indicates non-utilization of a prefetching function of the data prefetcher;
adjusting the count in a second direction in response to detection of an event that indicates utilization of the prefetching function; and
temporarily disabling the prefetching function when the count satisfies disable criteria, resulting in a disabled prefetcher state.

2. The method of claim 1, wherein:
adjusting the count in the first direction comprises decrementing the count by an amount; and
temporarily disabling the prefetching function is performed when the count reaches a threshold value.

3. The method of claim 1, wherein the event corresponds to an amount of time passed without detection of a cache miss.

4. The method of claim 1, wherein the event corresponds to an amount of cycles without detection of a cache miss.

5. The method of claim 1, wherein the event corresponds to a number of load requests without detection of a cache miss.

6. The method of claim 1, further comprising:
detecting a re-enabling event that occurs when the data prefetcher is in the disabled prefetcher state; and
re-enabling the prefetching function in response to detecting the re-enabling event, resulting in an enabled prefetcher state.

7. The method of claim 6, further comprising adjusting the count in the second direction in response to detecting the re-enabling event.

8. The method of claim 7, wherein adjusting the count in the second direction comprises incrementing the count by an amount.

9. The method of claim 7, wherein adjusting the count in the second direction comprises resetting the count to an initial count value.

10. The method of claim 1, wherein adjusting the count in the second direction is performed in response to detection of a cache miss.

11. A data prefetcher comprising:
a controller to control operation of the data prefetcher, the controller configured to receive data associated with cache misses and data associated with events that do not rely on a prefetching function of the data prefetcher; and
a counter to maintain a count associated with the data prefetcher, the count being adjusted in a first direction in response to detection of a cache miss, and the count being adjusted in a second direction in response to detection of an event that does not rely on the prefetching function;
wherein the controller disables the prefetching function when the count reaches a threshold value.

12. The data prefetcher of claim 11, wherein the event corresponds to an amount of time passed without detection of a cache miss.

13. The data prefetcher of claim 11, wherein the event corresponds to an amount of cycles without detection of a cache miss.

14. The data prefetcher of claim 11, wherein the event corresponds to a number of load requests without detection of a cache miss.

15. The data prefetcher of claim 11, wherein the event that does not rely on the prefetching function comprises a cache hit event.

16. The data prefetcher of claim 11, wherein the controller re-enables the prefetching function in response to detection of a cache miss event that occurs when the data prefetcher is disabled.

17. The data prefetcher of claim 16, wherein the counter resets the count to an initial count value when the controller re-enables the prefetching function.

18. A processor system comprising:
an execution core;
a cache memory coupled to the execution core; and
a data prefetcher coupled to the cache memory, wherein a prefetching function of the data prefetcher is disabled upon detection of a sequence of events that do not utilize the prefetching function.

19. The processor system of claim 18, wherein the sequence of events corresponds to a sequence of cache hits detected over an amount of time without a cache miss.

20. The processor system of claim 18, wherein the sequence of events corresponds to a sequence of cache hits detected over an amount of cycles without a cache miss.

21. The processor system of claim 18, wherein the sequence of events corresponds to a sequence of load requests without a cache miss.

22. The processor system of claim 18, wherein the data prefetcher comprises:
a controller to control operation of the data prefetcher, the controller configured to receive data associated with cache misses and data associated with events that do not utilize the prefetching function; and
a counter to maintain a count associated with the data prefetcher, the count being adjusted in a first direction in response to detection of at least one cache miss, and the count being adjusted in a second direction in response to detection of at least one event that does not utilize the prefetching function;
wherein the controller disables the prefetching function when the count reaches a threshold value.

23. The processor system of claim 18, wherein:
the prefetching function is re-enabled in response to detection of a re-enabling event that occurs when the data prefetcher is disabled; and
the re-enabling event utilizes the prefetching function.

24. The processor system of claim 23, wherein the re-enabling event is at least one cache miss that occurs when the data prefetcher is disabled.

25. The processor system of claim 18, wherein the prefetching function of the data prefetcher is disabled when no cache miss has been detected for a period of time.
